(19) United States
(12) Patent Application Publication
(10) Pub. No.: US 2005/0268436 A1
(43) Pub. Date: Dec. 8, 2005

(54) Cord lock and article holding mechanism

(75) Inventor: Manabu Yoshiguchi, Kamakura-shi (JP)

Correspondence Address: KANESAKA BERNER AND PARTNERS LLP, SUITE 300, 1700 DIAGONAL RD, ALEXANDRIA, VA, 22314-2848, US

(73) Assignee: NIFCO INC., Yokohama-shi (JP)

(21) Appl. No.: 11/141,048

(22) Filed: Jun. 1, 2005

(30) Foreign Application Priority Data
Jun. 3, 2004 (JP) 2004-165841

(51) Int. Cl. F16G 11/00

(52) U.S. Cl. 24/115 G

(57) ABSTRACT

A cord lock includes a male member having a through hole in a side portion thereof for inserting a cord and one shaft end as an operating section for a push-in operation, and a female member including a tubular housing section having through holes in a side portion thereof at opposing locations for inserting the cord and one open shaft end. The male member is inserted into the housing section through the open end along a tube axis from the other end of the male member. An urging device always urges the male member in a direction that the operating section projects outwardly from the open end of the female member.

### BACKGROUND OF THE INVENTION AND RELATED ART STATEMENT

The present invention relates to a cord lock for stretching a cord with adjusted tension across an outer surface of an article of various types. The present invention also relates to an article holding mechanism provided with the cord lock to stretch a cord with adjusted tension across a surface of a baggage, bag, or the like for holding an article of various types between the surface and the stretched cord in a sandwiched state.

Patent Reference 1 has disclosed a system in which a cord is stretched across a surface of a backpack opposite to a backside surface with shoulder straps to be on a back of a user, so that an article is held between the surface and the cord in a sandwiched state. In the system disclosed in Patent Reference 1, the cord is routed, and it is difficult to change a length of the routed portion to adjust tension of the cord. When a cord lock capable of adjusting an attaching position is attached to an end of the cord, it is possible to change a length of the routed portion of the cord beyond the position where the cord lock is attached.

However, it is difficult to simultaneously insert an article to be held between the cord and the backside surface and adjust the attaching position of the cord lock. Accordingly, even if such a cord lock is attached to the system disclosed in Patent Reference 1, it is difficult to hold an article with the cord at an appropriate holding location.

Patent Reference: Japanese Patent Publication (Kokai) No. 2000-203626

In view of the problems described above, an object of the present invention is to provide a cord lock for holding an article to be held between a cord and a surface of an article of various types, in which it is easy to adjust tension of the cord and insert the article.

Further objects and advantages of the invention will be apparent from the following description of the invention.

### SUMMARY OF THE INVENTION

In order to attain the objects described above, according to the present invention, a cord lock comprises a male member with a shaft shape having a through hole in a side portion thereof for inserting a cord and one shaft end as an operating section for a push-in operation; a female member including a tubular housing section having through holes in a side portion thereof at opposing locations for inserting the cord and one open shaft end; and an urging device for always urging the male member in a direction that the operating section projects outwardly from the open end of the female member. The male member is inserted into the housing section of the female member through the open end along a tube axis from the other end of the male member

When the male member is inserted with the operating section against the urging device, the through hole of the male member is aligned with the through holes of the female member, so that the cord passes through the through holes without resistance. The tubular housing section of the female member includes a cord extending projecting rim having at least two cord pass-through sections.

With the construction described above, it is possible to stretch the cord with adjusted tension across an article having at least three cord hooking parts on an outer surface thereof. In other words, the cord can be routed across the outer surface by lacing both ends of the cord through the through holes of the cord lock, to be fastened upon achieving the state wherein a mid section of the cord is alternately hooked and laced through the hooking parts and the pass-through sections, so that the mid section forms at least three article holding limbs radially extending from the cord lock located in the center. By inserting an article between the three article holding limbs of the cord routed across the surface as described above, the article can be held in a sandwiched state between the two.

When an article is inserted into a space between the cord routed across described above and the outer surface of the article, grabbing and lifting the cord lock lifts the article holding limbs in such a way that the space between the cord and the outer surface of the article increases as it approaches the cord lock. Accordingly, it is easy to insert the article to be held in a sandwiched state between the cord so lifted and the outer surface of the article.

When the cord holding the article in place is slack, the cord tension can be increased, so that the cord presses the article against the outer surface by pushing the male member with one hand against the urging device to unlock the cord from the cord lock while lifting the cord lock to insert the article, as described above. At the same time, both ends of the cord are grabbed and pulled with the other hand to reduce the length of the mid section of the cord beyond the position where the cord is fastened by the cord lock. Accordingly, it is easy to achieve an appropriate adjustment to the grip on the article.

The article sandwiched between the cord and the outer surface of the article can be released with one motion, namely, by lifting the cord lock while pushing the male member against the urging force of the urging device. The cord extending projecting rims of the female member described above may also be constructed as an annular flange which projects from the tubular housing section so as to surround the axis of the tubular housing section. The cord pass-through sections may also be constructed as through holes leaving a space between circumferentially adjacent pass-through sections of the annular flange.

With the configuration described above, the cord can be appropriately routed across the outer surface of the article, so that the article holding limbs extend radially from the cord lock located in the center simply by lacing the cord through the through holes. In addition, the sliding resistance of the cord routed by lacing through the pass-through sections can be minimized, and the cord can be routed across the outer surface of the article in such a way that each of the article holding limbs extending out after passing through the respective pass-through section is given roughly the same tension to the extent possible.

According to the present invention, an article holding mechanism comprises the cord lock described above; at least three cord hooking parts disposed on one surface of a baggage, bag or the like, and a cord. The cord is routed across the surface by lacing both ends of the cord through the through holes of the cord lock to be fastened upon achieving the state wherein the mid section of the cord is alternately hooked and laced through the hooking parts and the pass-through sections, so that the mid section forms at least three article holding limbs radially extending from the cord lock located in the center.

With this construction, an article inserted between the article holding limbs of the cord routed described above and the surface can be held in a sandwiched state between the two. Thus, an article, such as a pair of gloves or a towel, is held easily outside the baggage, bag or the like. When an article is inserted into the space between the cord routed across as described above and the outer surface of the article, grabbing and lifting the cord lock will lift the article holding limbs in such a way that the space between the cord and the outer surface of the article increases as it approaches the cord lock. Accordingly, it is easy to insert the article between the cord so lifted and the outer surface of the article to be held therebetween.

When the cord that is holding the article in place is slack, the cord tension can be increased, so that the cord presses the article against the outer surface by pushing in the male member with one hand against the urging force of the urging device to unlock the cord from the cord lock while lifting the cord lock to insert the article, as described above, and, at the same time, grabbing and pulling both ends of the cord with the other hand to reduce the length of the mid section of the cord beyond the position where the cord is fastened by the cord lock. Accordingly, it is easy to achieve an appropriate adjustment to the grip on the article. The article sandwiched between the cord and the outer surface of the article can be released with one motion, namely, by lifting the cord lock while pushing in the male member against the urging force of the urging device.

According to the present invention, a reflector may be provided in the operating section of the male member of the cord lock. With this construction, the operating section of the male member of the cord lock appears to be glowing as one portion of incident light is reflected by the reflector when the baggage, bag, or the like with the article holding mechanism is in use, thereby enhancing the safety of the user of the baggage or the like when walking.

According to the cord lock of the present invention, the cord routed across the outer surface of an article of various types for holding an object that is sandwiched therebetween can be installed on the article in such a manner as to enable easy cord tension adjustment and insertion operation.

According to the article holding mechanism of the present invention, the cord routed across one surface of a baggage, bag, or the like for holding an object that is sandwiched therebetween can be installed on the surface in such a manner as to enable easy cord tension adjustment and insertion operation.

### BRIEF DESCRIPTION OF THE DRAWINGS

FIG. 1 is a perspective view of a cord lock according to the present invention;

FIG. 2 is an exploded perspective view of the cord lock without an urging device;

FIG. 3 is a front view of the cord lock;

FIG. 4 is a right side view of the cord lock;

FIG. 5 is a plan view of the cord lock;

FIG. 6 is a back view of the cord lock;

FIG. 7 is a sectional view taken along line 7-7 in FIG. 3;

FIG. 8 is a sectional view taken along line 8-8 in FIG. 3;

FIG. 9 is a front view of an article holding mechanism and a partial perspective view (circled section) of an important part thereof; and

FIG. 10 is an enlarged front view of a central portion of the article holding mechanism in FIG. 9.

### DETAILED DESCRIPTION OF PREFERRED EMBODIMENTS

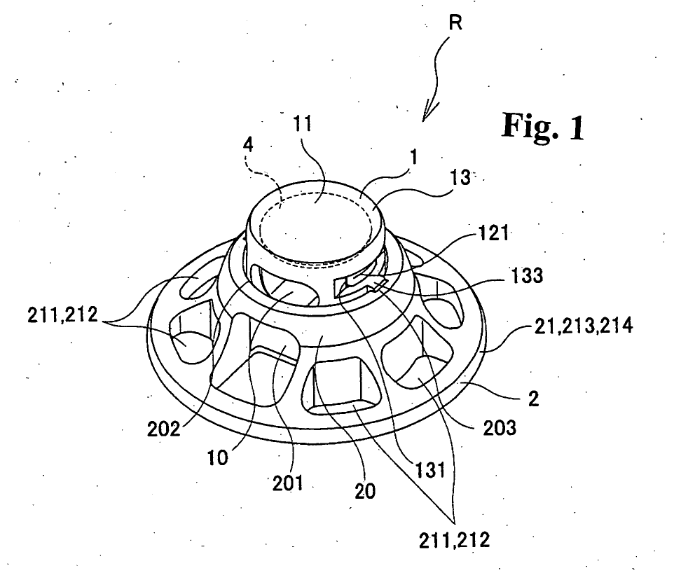

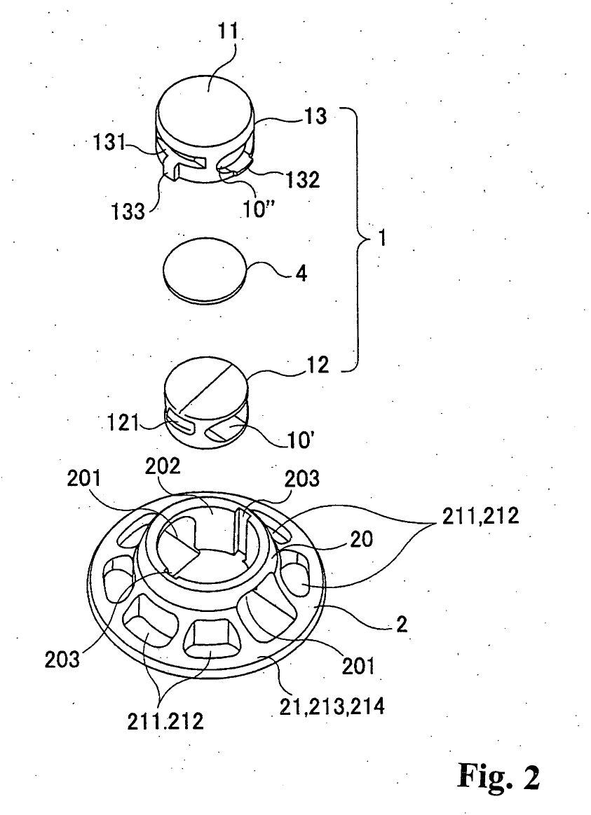

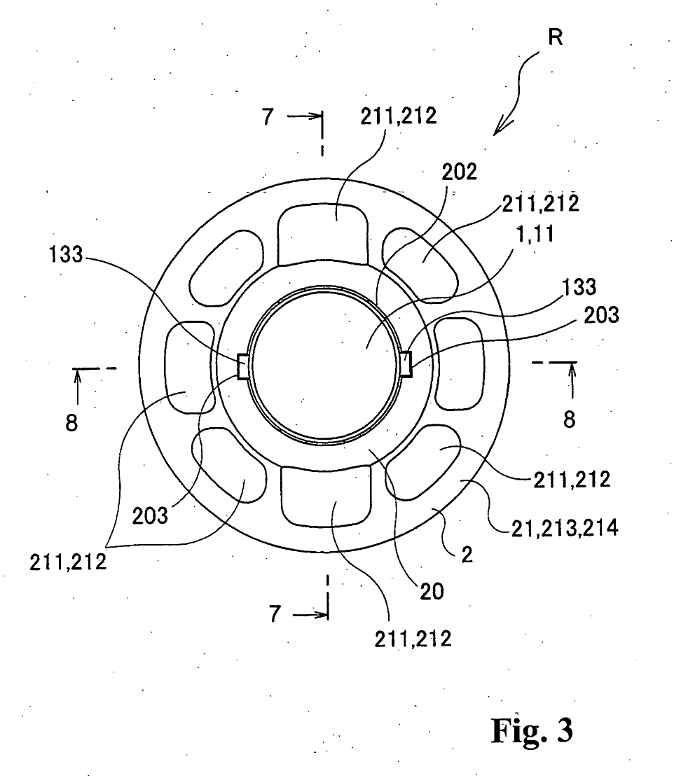

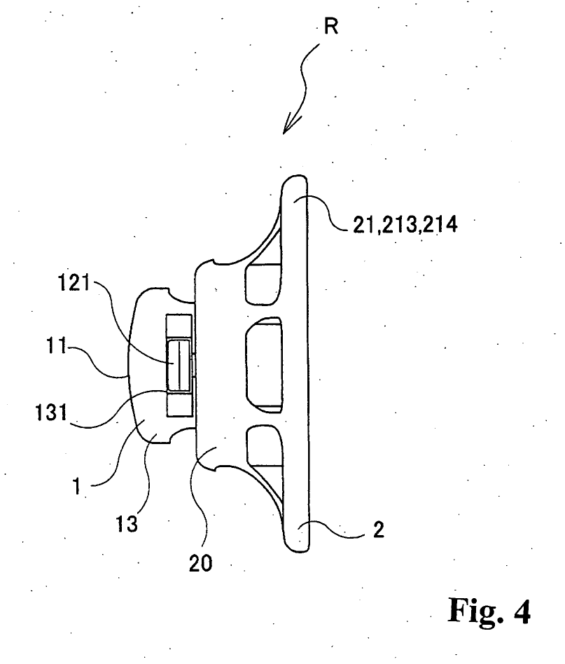

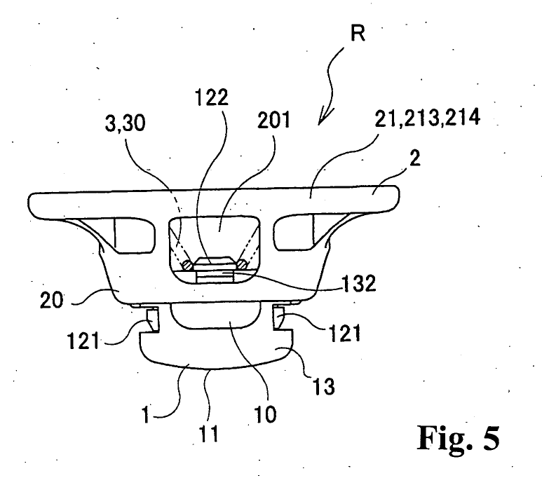

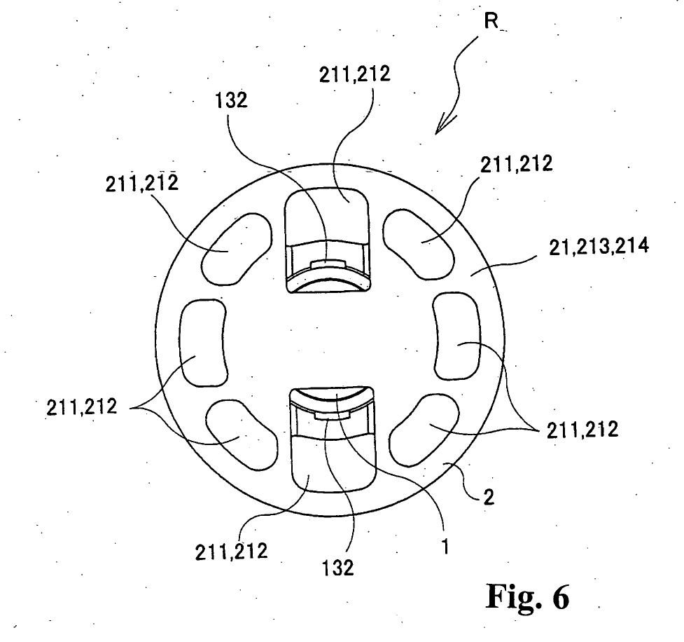

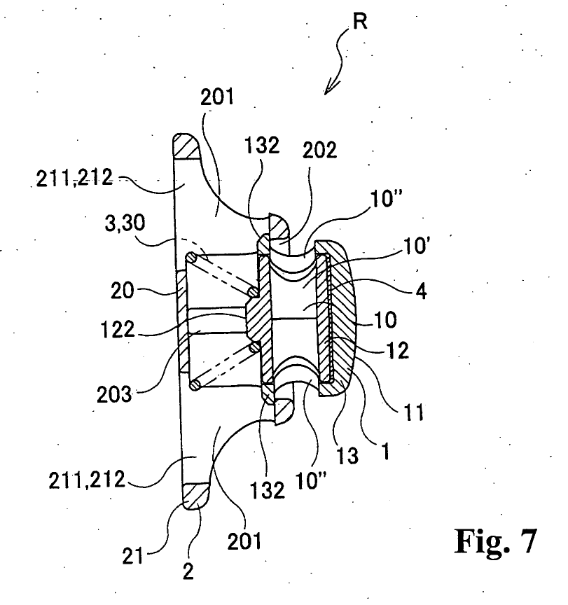

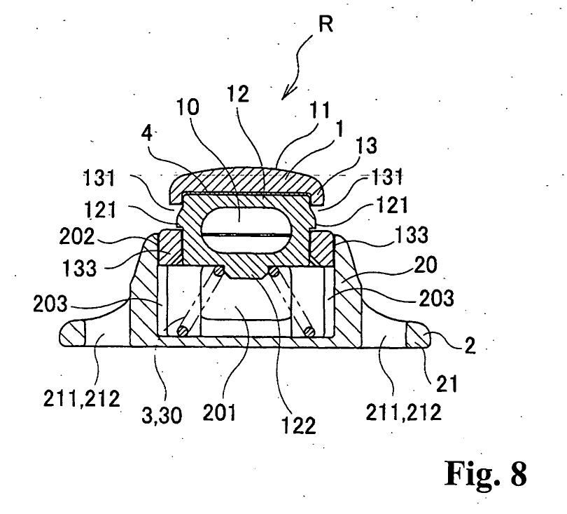

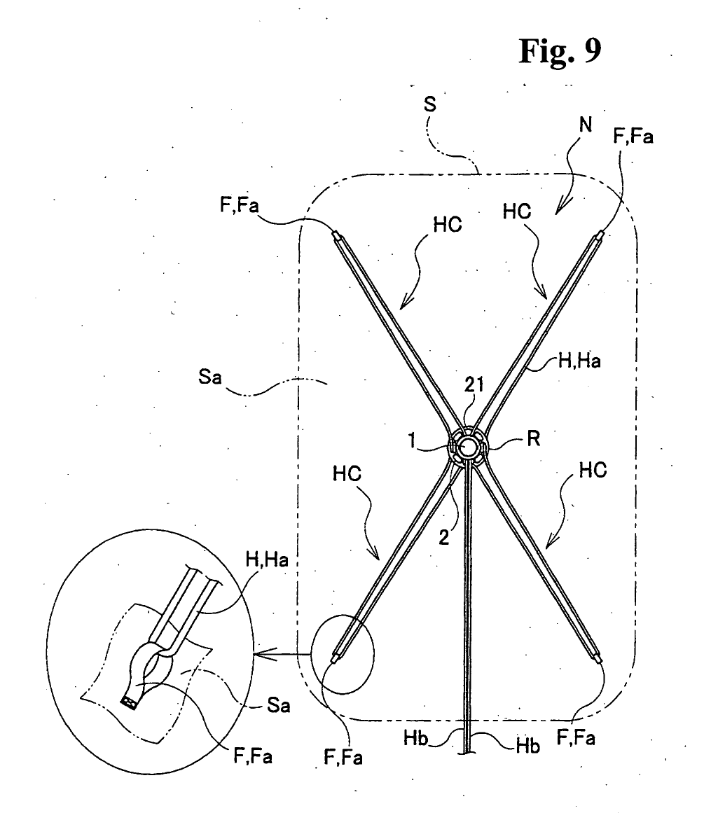

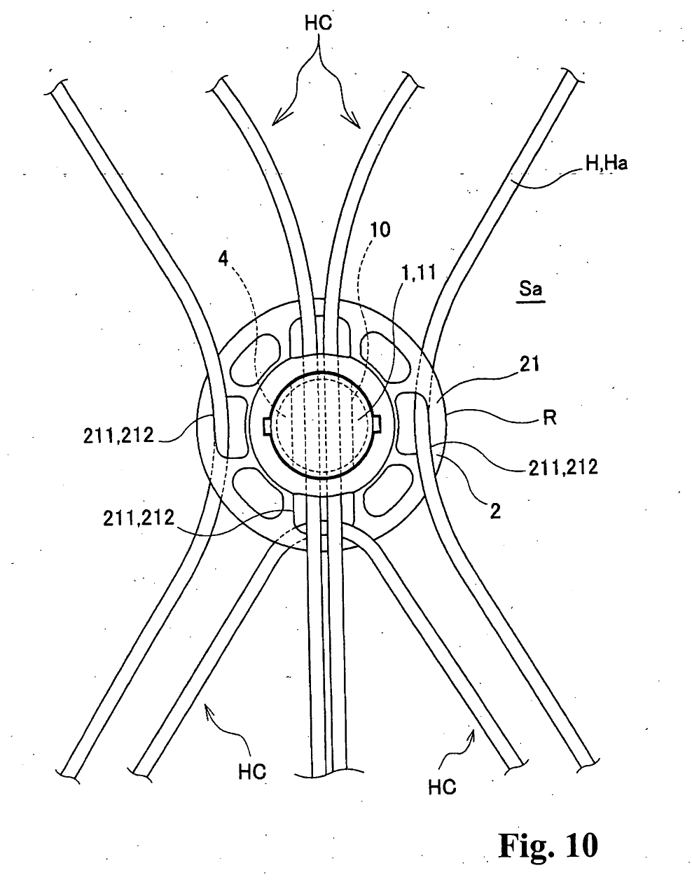

Hereunder, embodiments of the present invention will be explained with reference to the accompanying drawings. FIGS. 1 to 8 show a cord lock R according to an embodiment. FIG. 9 shows an article holding mechanism N with the cord lock R. In FIG. 9, an outline of a baggage, bag, or the like with the article holding mechanism N is indicated by a phantom line. FIG. 10 is an enlarged view of an important part of the article holding mechanism N.

In the embodiment, the cord lock R is used to stretch a cord H across an outer surface of an article S of various types so that the tension is adjustable. The article holding mechanism N is provided with the cord lock R, wherein the cord H that is tension-adjustably stretched across one surface Sa of a baggage, bag, or the like holds an article to be held in a sandwiched state between the surface and the cord H. As such a cord H, one made of a rubber or elastic plastic material having a circular, oval, or flattened oval cross-section is typically anticipated.

(Cord Lock R)

The cord lock R in this embodiment has a male member 1, a female member 2, and an urging device 3. The male member 1 is shaft-shaped, with one shaft end serving as an operating section 11 for insertion, and includes through holes 10 for the cord H in the side portion thereof.

In the example shown in the figures, the male member 1 comprises a short-sized tubular body 12 and a short-sized tubular cover 13 with one tubular end closed. The body 12 has through holes 10′ for the cord 11 that are opened in diametrical positions on the side portion, and includes engaging projections 121 in the areas between the through holes 10′. It also has a protruded portion 122 disposed substantially in the center of the lower end face. The protruded portion 122 is inserted, the upper end first, into a compression coil spring 30, which comprises a urging device 3, to be combined with the spring.

The cover 13 is constructed to have a diameter that allows the body 12 to be tightly fitted therein, with the upper end of the body 12 entering first from the open end of the cover 13. In the side portion of the cover 13, through holes 10″ for the cord H are formed in diametrical positions. The through holes 10″ of the cover 13 and the through holes 10′ of the body 12 are aligned with one another when the body 12 is fully inserted into the cover 13. Windows 131 are formed in the areas between the through holes 10″ formed in two locations of the cover 13.

When the body 12 is led into the cover 13, as mentioned above, the cover 13 resiliently stretches out once as the inner surface thereof is pressed against the projections 121, and regains its original shape at the position where the projections 121 of the body 12 are allowed to fit into the windows 131. As a result, the corresponding projections 121 penetrate into and are caught by the windows 131, thereby integrating the cover 13 and the body 12.

Anti-slip projections 132 are formed on the outer surface of the cover 13 at the lower edges of the through holes 10″ of the cover 13. When the male member 1 is led into the tubular housing section 20 of the female member 2 (described later), the tubular housing section 20 resiliently stretches out once as the inner surface thereof is pressed against the anti-slip projections 132, and regains its original shape at the position where the anti-slip projections 132 are allowed to fit into the through holes 201 created in the tubular housing section 20. As a result, the corresponding anti-slip projections 132 penetrate into the through holes 201 from the inside, thereby preventing the male member 1 from slipping out of the tubular housing section 20 beyond the position where the anti-slip projections 132 are abutted against the upper edge of the through holes 10 of the female member 2 from below, regardless of the urging force of the urging device 3.

Ribs 133 extending along the axis line of the male member 1 are created on the outer surface of the cover 13 across and between the lower edges of the windows 131 and the lower end of the cover 13. The male member 1 and the female member 2 are joined with the ribs 133 fitted into guide grooves 203 formed in the inner wall of the tubular housing section 20 of the female member 2 (described later), extending along the tube axis of the female member 2.

In this embodiment, the cover 13 is made of a translucent material, typically a clear colorless plastic material, and the cover 13 and the body 12 are joined with a sheet-formed reflector 4 interposed between the inner face of the closed tubular end of the cover 13 and the upper end face of the body 12. Therefore, the reflector 4 reflects a portion of incident light to allow the operating section 11 of the male member 1 in the cord lock R to appear to be glowing when using the article S furnished with the cord H tension-adjustably stretched by the cord lock R across the outer surface of the article S. As such a reflector 4, a reflective sheet or reflector plate typically may be used.

The female member 2 includes a tubular housing section 20 having through holes 201 for the cord H at opposing locations in a tube side portion, leaving one end open, for movably housing the male member 1 along the shaft axis from the other end entering first from the opening 202.

In the example shown in the figures, the tubular housing section 20 has a short cylindrical shape with the lower end closed. The trough holes 201 are formed at diametrical positions in the side section of the tubular housing section 20. In the example shown in the figures, moreover, the guide grooves 203 are formed at positions between the two through holes 201. The guide grooves 203 are formed from the lower end of the tubular housing section 20 across the upper end of the tubular housing section 20, which is the open end, and the upper groove ends are opened outwardly at this upper end.

The tubular housing section 20 of the female member 2 has a projecting rim 21 for extending the cord H, which includes pass-through sections 211 for the cord H in at least two locations. The cord extending projecting rim 21 of the female member 2 is constructed as an annular flange 213 projecting from the tubular housing section 20 so as to surround the tube axis of the tubular storage section 20. In addition, the pass-through sections 211 for the cord H are constructed as through holes 212 spaced apart from the circumferentially adjacent pass-through sections 212 in the annular flange 213.

More specifically, the annular flange 213 has a circular outline, and is formed on one surface of a disc-shaped part 214, so that the lower end of the tubular housing section 20 is integrally disposed in the center of the disc-shaped part 214. The annular flange 213 is provided with eight through holes 212 formed with a substantially equal spacing between the two adjacent through holes 212. Two of the eight through holes 212 diametrically positioned cave into the tubular housing section 20 so as to cut out one portion of the closed lower end of the tubular housing section 20, and are connected with the lower portions of the through holes 201 of the female member 2 at these caved-in locations.

The urging device 3 is constructed so as to always urge the male member 1 in the direction, so that the operating section 11 of the male member 1 projects out of the opening 202 of the female member 2. The urging device 3 is a compression coil spring 30 wherein the upper spring end is combined with the male member 1 as described before, and the lower spring end is incorporated into the tubular housing section 20 of the female member 2 so as to press against the inner face of the closed lower tubular end of the female member 2. The urging device 3 may be constructed with a resilient piece of material, for example, which is integrally disposed at the other shaft end of the male member 1.

In this embodiment, insertion of the male member 1 employing the operating section 11 against the urging force of the urging device 3 aligns the through holes 10 of the male member 1 with the through holes 201 of the female member 2 so as to allow the cord to pass through without resisting these through holes 10 and 201 (an unlocked state).

The cord lock R comprising the features explained above achieves the following advantages: (1) The cord lock R allows the cord H to be tension-adjustably stretched across the article S having at least three hooking parts F for the cord H on the outer surface thereof. In other words, the cord H can be routed across the outer surface by lacing both ends Hb of the cord H through the through holes 10 of the cord lock R to be fastened upon achieving the state wherein the mid section Ha of the cord H is alternately hooked and laced through the hooking parts F and the pass-through sections 211, so that the mid section Ha forms at least three article holding limbs Hc radially extending from the cord lock R located in the center.

Specifically, where the pass-through sections 211 for the cord H are formed in at least two locations in the cord extending projecting rim 21 of the female member 2, the cord H is stretched across the outer surface of the article S so as to form at least three article holding limbs Hc radially extending from the cord lock R located in the center by routing the mid section Ha of the cord H through the first pass-through section 211 of the cord lock R after hooking it around the first hooking part F distantly located from the cord lock R, routing the mid section Ha pulled out of the first pass-through section 211 through the second pass-through section 211 of the cord lock R after hooking it around a second hooking part F, hooking the mid section Ha pulled out of the second pass-through section 211 around the third hooking part F, and then lacing both ends Hb through the through holes 10 of the cord lock R to be fastened. By inserting an article between the three article holding limbs Hc of the cord H stretched across as above and the outer surface of the article S, the article can held in a sandwiched state between the two.

When the pass-through sections 211 for the cord H are formed in at least three locations in the cord extending projecting rim 21 of the female member 2, the cord H can be routed across the outer surface of the article S so as to form at least four article holding limbs Hc radially extending from the cord lock R located in the center, as shown in FIG. 9.

When slipping an article into the space between the cord H routed across as described above and the outer surface of the article S, grabbing and lifting the cord lock R will lift the article holding limbs Hc in such a way that the space between the cord and the outer surface of the article S increases as it approaches the cord lock R, thereby enabling easy insertion of the article between the cord H so lifted and the article S to be held therebetween.

When the cord H that is holding the article in place is slack, the tension of the cord H can be increased, so that the cord H presses the article against the outer surface by pushing in the male member 1 with one hand against the urging force of the urging device 3 to unlock the cord H from the cord lock R while lifting the cord lock R to insert the article, as described above, and, at the same time, grabbing and pulling both ends Hb of the cord H with the other hand to reduce the length of the mid sections Ha of the cord H beyond the position where the cord is fastened by the cord lock R. This enables easy achievement of an appropriate adjustment to the grip on the article.

The grip on the article that is sandwiched between the cord H and the outer surface of the article S can be released with one motion, namely, by lifting of the cord lock R while pushing in the male member 1 against the urging force of the urging device 3.

In this embodiment, since the pass-through sections 211 for the cord H are the through holes 212 formed in the annular flange 213 leaving a space between circumferentially adjacent through holes 211, the cord H can be appropriately stretched across the outer surface of the article S, so that the article holding limbs Hc radially extend from the cord lock R located in the center, simply by lacing the cord H through the through holes 212. In addition, the sliding resistance of the cord H that is routed by lacing through the pass-through sections 211 can be minimized, and the cord H can be routed across the outer surface of the article S in such a way that each of the article holding limbs Hc extending out after passing through the respective pass-through section 211 is given roughly the same level of tension, to the extent possible.

The provision of a resilient deformation characteristic to the sections in the cord lock R explained above that are supposed to have the resilient deformation characteristic can easily be ensured by constructing the male member 1 and the female member 2 comprising the cord lock R typically with plastic moldings.

(Article Holding Mechanism N)

The article holding mechanism N in this embodiment comprises the cord lock R explained above, at least three hooking parts F for cord H disposed on the surface Sa (in the example shown in the figures, the surface opposite to the surface having shoulder straps that contacts a back of a user) of a baggage, bag, or the like (in the example shown in the figures, a backpack), and the cord H.

The hooking part F may be constructed with a hook or the like installed on the surface via a tape or the like. In the example shown in the figures, it is constructed with a looped tape Fa with both ends fastened to the surface. Pairs of right and left hooking parts F are disposed on the upper portion and the lower portion of the backpack at spaced apart locations, providing the hooking parts F in four locations of the surface.

In such an article holding mechanism N, the cord H is stretched across the surface by lacing the both ends Hb of the cord H through the through holes 10 of the cord lock R to be fastened upon for achieving the state wherein the mid section Ha of the cord H is alternately hooked and laced through the hooking parts F and the pass-through sections 211, so that the mid section Ha forms at least three article holding limbs Hc radially extending from the cord lock R located in the center.

According to the article holding mechanism N, therefore, an article inserted between the article holding limbs Hc of the cord H routed as described above and the surface can be held in a sandwiched state between the two. Thus, the article such as a pair of gloves or a towel may easily be held outside of the baggage, bag, or the like.

When slipping an article into the space between the cord H routed across as described above and the one surface, grabbing and lifting the cord lock R will lift the article holding limbs Hc in such a way that the space between the cord and the outer surface of the article S increases as it approaches the cord lock R, thereby enabling easy insertion of the article between the cord H so lifted and the article S to be held therebetween.

When the cord H that is holding the article in place is slack, the tension of the cord H can be increased, so that the cord H presses the article against the outer surface by pushing in the male member 1 with one hand against the urging force of the urging device 3 to unlock the cord H from the cord lock R while lifting the cord lock R to insert the article, as described above, and, at the same time, grabbing and pulling both ends Hb of the cord H with the other hand to reduce the length of the mid section Ha of the cord H beyond the position where the cord is fastened by the cord lock R. This enables easy achievement of an appropriate adjustment to the grip on the article.

The grip on the article that is sandwiched between the cord H and the outer surface of the article S can be released with one motion, namely, by lifting the cord lock R while pushing in the male member 1 against the urging force of the urging device 3.

In the example shown in the figures, a reflector 4 is provided to the operating section 11 of the male member 1 of the cord lock R. The reflector 4 may also be provided in the operating section 11 of the male member 1 by pasting a reflective tape so as to cover the front section or a portion of the operating section 11. The sheet-formed reflector 4 is interposed between the body 12 and the cover 13 of the male member 1, so that the reflector 4 is built into the operating section 11, as described earlier.

In the example shown in the figures, therefore, the operating section 11 of the male member 1 of the cord lock R appears to be glowing as one portion of incident light is reflected by the reflector 4 when the baggage, bag or the like, which includes the article holding mechanism N, is in use, thereby enhancing the safety of the user of the baggage or the like when walking.

The disclosure of Japanese Patent Application No. 2004-165841, filed on Jun. 3, 2004, is incorporated in the application.

While the invention has been explained with reference to the specific embodiments of the invention, the explanation is illustrative and the invention is limited only by the appended claims.

1. A cord lock comprising:
a male member having a first through hole in a side portion thereof for inserting a cord, and an operating section at one end thereof for a push-in operation;
a female member including a tubular housing section having second through holes in a side portion thereof at opposing locations for inserting the cord, one open end for inserting the male member into the housing section through the open end along a tube axis, and a projecting rim radially outwardly extending from the tubular housing section and having at least two pass-through sections therein; and
an urging device disposed in the female member for always urging the male member in a direction that the operating section projects outwardly from the open end of the female member so that when the male member is pushed into the female member with the operating section against an urging force of the urging device, the first through hole is aligned with the second through holes to allow the cord to pass through the first through hole and the second through holes.

2. A cord lock according to claim 1, wherein said projecting rim includes an annular flange projecting from the tubular housing section around the axis thereof, said cord pass-through sections having third through holes formed in the annular flange with a space in between along a circumferential direction thereof.

3. A cord lock according to claim 2, wherein said male member includes anti-slip projections formed at edges of the first through hole of the male member to prevent the male member from ejecting outwardly after the male member is assembled with the female member.

4. A cord lock according to claim 3, wherein said male member includes at least one rib extending along an axis of the male member, and said tubular housing includes at least one guide groove engaging the at least one rib to guide the male member.

5. A cord lock according to claim 1, wherein said male member is formed of a tubular body and a tubular cover for covering the tubular body therein.

6. An article holding mechanism for holding an article comprising the cord lock according to claim 1, at least three cord hooking parts disposed on one surface of the article, and a cord so that the cord can pass through the first and second through holes and the pass-through sections to hold the at least three cord hooking parts by the cord and the cord lock.

7. An article holding mechanism according to claim 6, further providing a reflector on the operating section of the male member.
